(19) United States
(12) Patent Application Publication
(10) Pub. No.: US 2015/0379626 A1
(43) Pub. Date: Dec. 31, 2015

(54) Web Based My Budget My Choice Automated Bid Search Engine

(71) Applicants: Rupak Kumar Choudhury, Bangalore (IN); Nimai Chandra Gorai, Bangalore (IN)

(72) Inventors: Rupak Kumar Choudhury, Bangalore (IN); Nimai Chandra Gorai, Bangalore (IN)

(21) Appl. No.: 14/318,587

(22) Filed: Jun. 28, 2014

(51) Int. Cl. G06Q 30/08

(52) U.S. Cl. CPC G06Q 30/08

(57) ABSTRACT

A real time web based automated bid search software system over the internet, which enables the customers/buyers to search for live bids of goods or services with his/her/their desired budget or price and then purchase them through a fully automated auctioning and bidding process from the sellers/partners using reverse auction process. Customers need to provide the price/budget and other inputs of goods or services to be purchased in the search fields of this search system, the software system will automatically create an auction and launch on behalf of the customer and send asynchronous messages with the auction details to all registered sellers of the goods or services with the matching price/budget to participate in the auctioning/bidding process. Upon acceptance of the participation from the sellers/partners, the software system displays all the eligible sellers/partners with one or more offers with the initial bid price, wherein the sellers/partners would like to sell goods or services at the price less then or equal to the price defined by the customer. Upon seeing the search results, the customer can buy directly the goods or services at the initial bid price from a particular seller or he/she can choose (based on the seller's rankings) one or more sellers and submit the request to the system. Upon receiving this request, the system will send asynchronous messages or email or SMS to the sellers to participate and bid for the goods/services and price setup by the customer through the reverse auction process.

### FIELD OF THE INVENTION

This invention relates to e-commerce and live bid search for goods or services with a desired budget or price, and more particular to search and buy goods or services through reverse auctioning process with desired budget or price.

### BACKGROUND

In a typical electronic auctioning system, sellers set up the auctions and buyers bid for the auctions setup by the Sellers. On the contrary, in reverse auctioning systems, buyers set up the auctions and sellers bids for the auctions setup by buyers. In both of the above cases, buyers/customers will not have options to purchase required good or service by searching with his/her/their predefined budget/price and choice of sellers through auctioning/bidding process for the intended items. “My budget My Choice” bid search engine has a new method which enables the customers/buyers to search for live bids of goods or services with his/her/their desired budget or price and then purchase them through a fully automated computer enabled auctioning and bidding process from the sellers/partners using reverse auction process. The present software system enables the customers/buyers to initiate an auction for a required good or service within their budget/price and preferred vendors. Buyers having an option for defining the price and choosing the sellers for the same goods or services will greatly benefit on the price and the right sellers. At the same time seller's will also get benefited by knowing the information from their competitors on the price, their rankings, their services, terms and conditions on selling the goods or services to the customers. Also, both the buyers and seller's will greatly save their valuable time with this new system/method by eliminating the manual work on this process. The present software system enables the customers/buyers to initiate an auction for a required good or service within their budget/price and preferred vendors. Presently there is no software or solution for searching realtime live bids to purchase required goods or services with a desired price set by the customer/buyer. Therefore this system will greatly help customers/buyers and sellers/partners on the returns of their spend and time.

### SUMMARY

A cloud based, realtime, multi-tenant bid search software system, which will enable the customers (Buyers) to search and buy good or services (e.g. a meal in a restaurant or lunch/dinner or party arrangements or resort booking or list of items/groceries/food items/non-food items or hotel accommodation or live events or order food for home delivery, and outing events etc. for an individual/a team/a group/a family/etc.) on his/her choice at his/her own desired budget/price or lesser than that through an automated realtime reverse auction process from the sellers/partners/vendors. Customers can login into the portal, fill-in the required details such as the information related to goods or services, desired budget or price, bid discovery period and the date on which the customer would like to avail the services or receives the goods in the bid calendar (a search page pertaining to this system) and hit on the search button. The software system would then quickly analyze (with the help of computer algorithms) the input parameters/search criteria provided by the customer and perform search on the registered partners. The search engine would consider only the registered partners/participants/sellers/vendors in the system that are eligible to participate in the bidding process within the specified budget or the price limits set by the customer. During the time lag between the start and completion of the search (Bid Discovery Period), the software system will notify (via email & SMS) to all eligible partners/vendors/sellers on the new good or service request being posted by the customer. Partners can then accept to participate in the bidding process either by sending an SMS or by log-in into the portal by accepting the participation invitation with the initial bid price. Once all the eligible Partners (Sellers) accept the auction requests from the system or predefined time, the customer will then be able to see all the partners (willing to participate) in the search listing/result page with the initial bid price (s). The complete bid search results will be published or shown to the customer on or before the expiry of the bid discovery period. Customer may choose to buy (i.e. using ‘Buy Now’ option) any of the listed “Accepted” bid at any point of time. Customer may choose to further allow negotiation among the listed bids. If customer wants to further allow negotiation among the listed bids, he or she can select two or more “Accepted” bids from the listing and add those for bidding process. Customer can define the Bid Term (BT) for the bidding process. If no BT is defined, the platform determines the BT based on internal algorithms. Customer can optionally provide more information on his/her expectation on the goods or services he/she is looking for. The chosen list of “Accepted” bids along with other information (if any) are submitted to the Bidding Engine (BE). The sellers will continue bidding until the expiry of bid term. Once the bidding gets over, the customer will be notified on the bid completion through SMS/email. Upon receiving the SMS/email on the bid completion, customer can logs into the system and accept a bid from a specific seller by comparing the bids. The customer can either accepts a) the lowest priced bid from the seller or b) the bid which is on more additional aspects such as their ranking, location, reputation, more offers/goodies, etc. Once the bid is accepted by the customer, vouchers for the purchase will be generated and sent to the customer through email/SMS, the winning seller will be notified and auction ends.

### BRIEF DESCRIPTION OF THE DRAWINGS

FIG. 1: Components of Bid Search illustrates the functionality of each components pertaining to bid search

FIG. 2: Bid Search illustrates the flow of the bid search

FIG. 3: Auction & Bidding Process shows the process and flow of auction and bidding in the system.

FIG. 4: Customer Registration Flow illustrates flow chart for the customer registration.

FIG. 5: Partner Registration Flow illustrates the flow chart for the partner registration.

FIG. 6: High Level Deployment Architecture illustrates the high level architecture of this bid search system.

FIG. 7: Low Level Deployment Architecture illustrates the detailed architecture of this bid search system.

FIG. 8: Component Diagram illustrates the different components in this system.

FIG. 9: Bid State Diagram illustrates different states of a bid.

### DETAILED DESCRIPTION

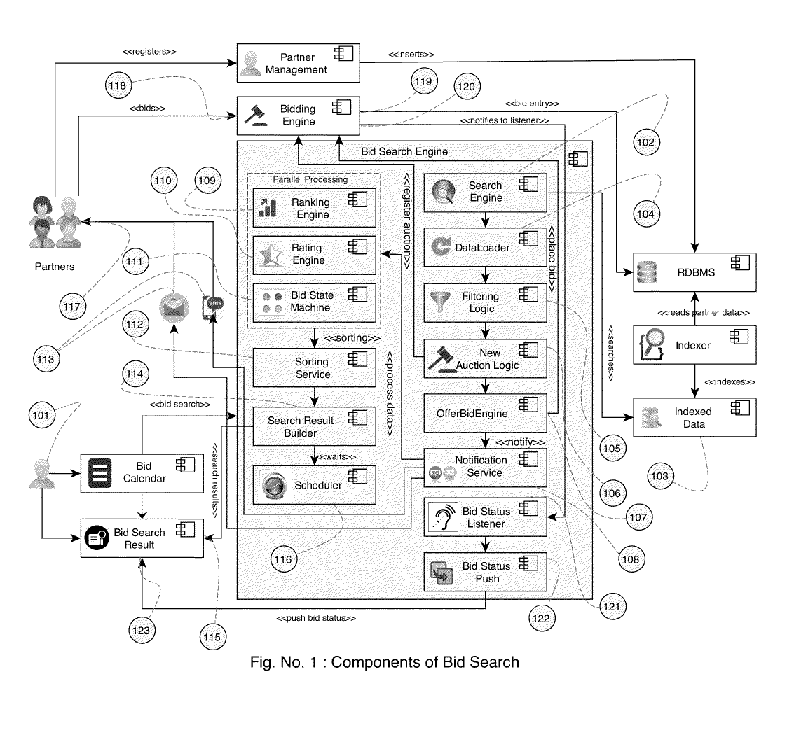

FIG. 1: Components of Bid Search illustrates high level block diagram of Bid Search engine. It lists down the major components/logic used in the bid search engine. Once the user keys in the desired criteria in the bid calendar form and submits, the request is posted to the Bid Search Engine. Bid Search Engine accepts and processes the request.

As shown, customer comes to the portal and visits the “Bid Calendar”. Customer keys in the desired details and clicks on search bid [101]. The Search Engine component [102] performs full text search in the partner indexed data [103]. This result is passed to the DataLoader [104] computer program/component. DataLoader loads the latest data from relational database. The latest partner dataset is passed to the BiddingOptionsFilter [105]. BiddingOptionsFilter evaluates various rules defined in the “Bidding Options” for each partner and accordingly determines the eligibility of the partner for bidding. BiddingOptionsFilter also validates if the budget of the customer for the desired good/service matches with one or more of the configured offers. All the eligible offer records are added to a list. If there is at least one eligible offer in the list, a new Auction [106] is created in the system. The list of eligible offers are then passed to the “OfferBidEngine” [107]. “OfferBidEngine” loops through each eligible offer. Each offer is carefully evaluated by the system for pricing. The appropriate price for the offer is determined by the system. If the offer has “auto-bid” enabled, system places a new bid against the new Auction on behalf of the partner. The offer with ‘Accepted’ bid status along with price is added to a search bid list. If the offer has “Review Before Bidding” configured, an approval flow is initiated by the system. The offer with ‘Pending Review’ bid status (price set a ‘none’) is added to a search bid list. As part of approval flow, the partner is notified (via SMS & Email) about the new auction [108]. The partners interested in bidding are expected to provide one or more offers for bidding within the Bid Discovery Period. The final bid list is simultaneously passed on to various engines for enriching.

Ranking engine [109]: Ranking engine takes care of ranking each bid/offer as per the bid search criteria.

Rating engine [110]: Rating engine takes care of attaching the ratings of each bid/offer based on user feedback/other factors.

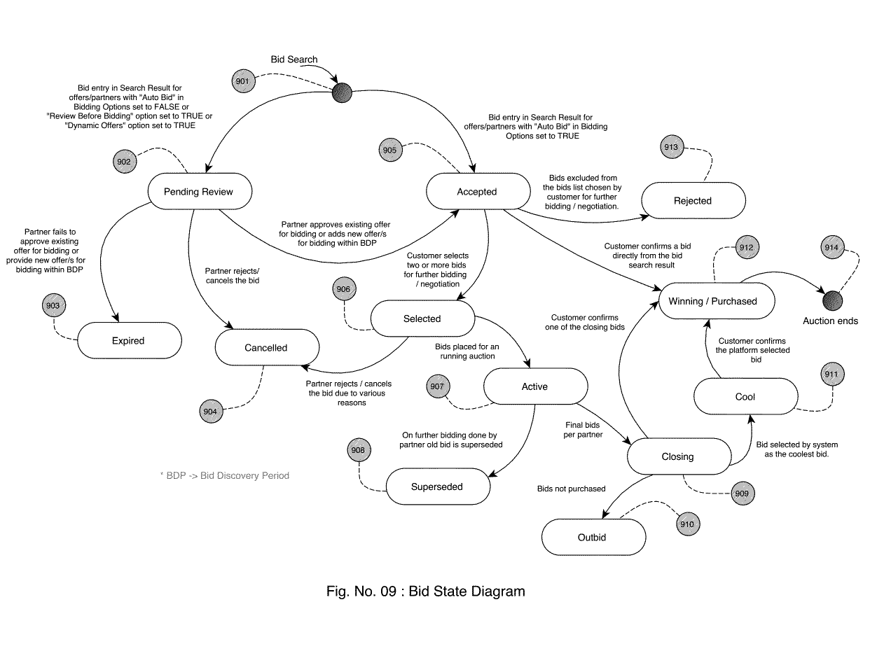

Bid Status Engine [111]: changes states of the bid, explained in FIG. 09.

The final bid result are sorted [112] by ranking and then by rating. The final result is serialized to JSON and written back to the response [114]. The search response is built in the search listing page [115].

For better performance, the bid results display is paginated. The bids with ‘Accepted’ bid status are listed with ‘Price’ & two buttons i.e. ‘Buy Now’ & ‘Add to negotiate’. The bids with ‘Pending Review’ bid status are listed with “Pending Review” displayed in the ‘Price’ section. ‘Buy Now’ & ‘Add to negotiate’ buttons are in disabled state. A ‘reverse ajax’ listener is initialized for listing to server's notification on ‘Pending Review’ bids. Customer is shown a message stating that all Pending Review’ bids are being processed and may take some time. In the meantime, partners receive notification regarding the new auction [117]. Partner can either login to the portal or respond to the SMS to bid against the auction [118]. Partners opted for dynamic offer needs to login to the platform to configure new offers/choose existing offers for bidding. As soon as the server receives one or more offers for bidding, bids is/are placed against the auction on behalf of the partner [119].

If the partner places one or more bids within the Bid Discovery Period, the bids are accepted and status is set to ‘Accepted’. System pushes the bids to the browser [122]. Browser picks up the bids and updates the bid search listing accordingly [123]. If the partner fails to place first bid within the Bid Discovery Period, the bid status is set to ‘Expired’.

Customer is allowed to pick up a bid and continue with the purchase. If the customer select a single bid and continues, the selected bid status is set to ‘Winning’ and remaining bid status are set to ‘Rejected’. Customer is also allowed to pick up multiple bids and initiate a reverse bidding process. All bids which are not selected by the Customer are set to ‘Rejected’.

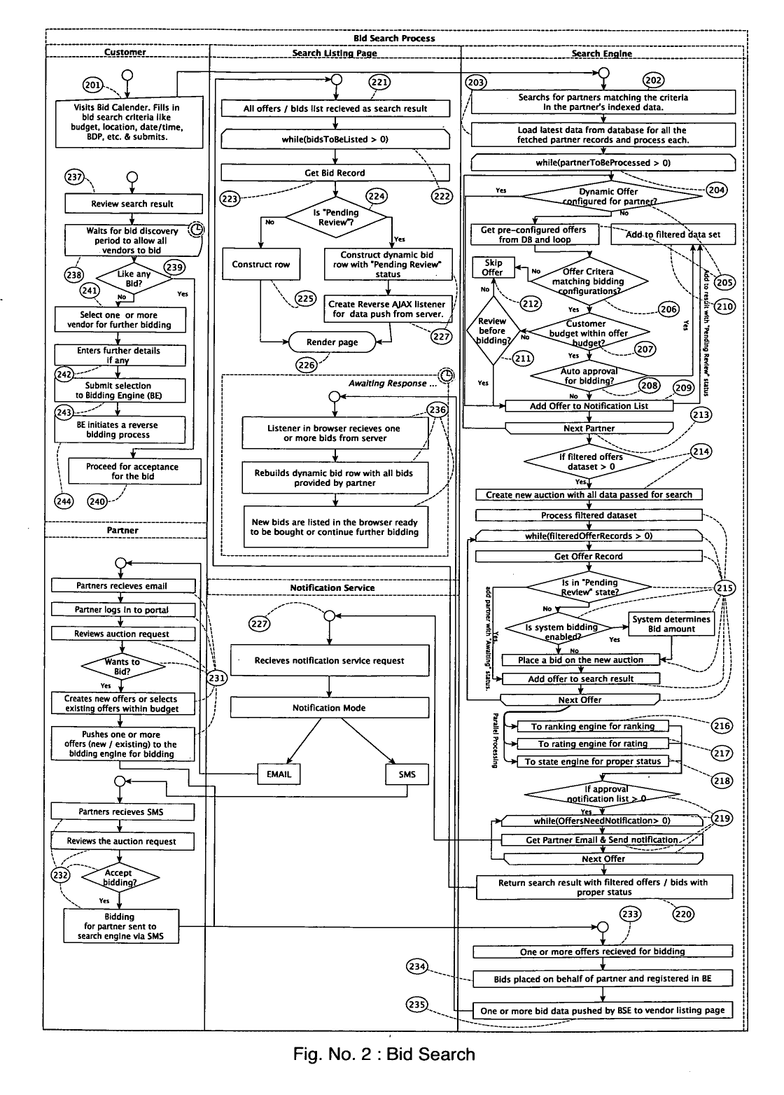

FIG. 2: Bid Search illustrates the flow and process of the bid search engine

The assumption here is that the customer is a valid user in the system and is already logged-in to the platform.

As shown in FIG. 2, customer comes to the platform and visits the “Bid Calendar”. Customer keys in the desired date, time, budget and location [201]. Customer clicks on search bid to perform search [201]. The Search Engine (SE) receives the bid search request. The Search Engine [202] performs full text search in the partner indexed data. For all partners listed as part of the search result is passed to the DataLoader [203] computer program. Data Loader loads the latest data from relational database. The latest partner dataset is passed to the BiddingOptionsFilter computer program. BiddingOptionsFilter loops through each partner record [204,205]. If partner has chosen and configured the “Dynamic Offer” option, a notification request for the offer is created and added to the notification list [209]. For partner record with no dynamic offer, all pre-configured offers are fetched from database. BSE evaluates various rules defined in the “Bidding Options” for each offer [206] and accordingly determines the eligibility of the offer for bidding. If the offer's “Bidding Options” criteria don't match with the bid search criteria, the offer is skipped [212]. BiddingOptionsFilter also validates if the budget of the customer for the desired good/service is within the budget of the offer [207]. If the customer budget is not within the offer budget and Partner has configured for “Review Before Bidding”, a notification request for the offer is created and added to the notification list [209]. The offer is added to the eligible offer list with “Pending Review” status [210]. If the customer budget is not within the offer budget and Partner has not configured for notification, the offer is omitted [211]. If the customer budget is within the offer budget and Partner has configured for “Auto Bid”, the offer is added to the eligible offer list with “Accepted” status. If the customer budget is within the offer budget and Partner has configured for “Review Before Bidding”, a notification request for the offer is created and added to the notification list. The offer is added to the eligible offer list with “Pending Review” status [210]. All the eligible offer records are added to a list [210]. If there is at least one eligible offer in the list, a new Auction [214] is automatically created in the system. The list of eligible offers is then passed to the “OfferBidEngine”. “OfferBidEngine” loops through each offer. If the offer has “Accepted” status, system places a new bid against the new Auction on behalf of the partner. Appropriate price is set for the bid in the bid search list. If the offer has “Pending Review” status, an approval flow is initiated by the system. “None” is set as the price for the bid in the bid search list [215].

As part of approval flow, the partner is notified (via SMS & Email) about the new auction [219]. The partner is required to provide offer/s (i.e. new/existing) for bidding within the Bid Discovery Period. The final bid list is simultaneously passed on to various engines for enriching. Ranking engine [216]: Ranking engine takes care of ranking each bid/offer as per the bid search criteria. Ranking is done based on the weightage of the search attributes in the bidding search criteria. Ranking also takes in account of the user's dining behavior (based on historical data). Rating engine [217]: Rating engine takes care of attaching the ratings of each bid/offer based on user feedback/other factors. Bid Status Engine [218]: Bid status check if done for all the bids in “Pending Approval” state. The final bid result are sorted [220] by ranking and then by rating. The final result is serialized to JSON and written back to the response [220]. The search response is built in the search listing page [221]. For better performance, the bid results display is paginated.

The bids with ‘Accepted’ bid status are listed with ‘Price’ & two buttons i.e. ‘Buy Now’ & ‘Add to negotiate’ [225,226]. The bids with ‘Pending Review’ bid status are listed with “Pending Review” displayed in the ‘Price’ section. ‘Buy Now’ & ‘Add to negotiate’ buttons are in disabled state [227,226]. A ‘reverse ajax’ listener is initialized for listening to server's notification on ‘Pending Review’ bids [227]. User is shown a message stating that all ‘Pending Review’ bids are being processed and may take some time. In the meantime, partners receive notification regarding the new auction [231,232]. Partner can either login to the portal or respond to the SMS to provide offers for bidding against the auction [231,232]. Partners opted for dynamic offer needs to login to the platform to configure new offers/choose existing offers for bidding. As soon as the server receives one or more offers for bidding, bid/s are placed against the auction on behalf of the partner [233]. If the partner places one or more bids within the Bid Discovery Period, the bid/s status is/are set to ‘Accepted’ [234]. System pushes one or more bids to the browser [235]. Browser picks up the bids and updates the bid search listing accordingly [236]. If the partner fails to place any bid within the Bid Discovery Period, the bid status (in bid listing page as well as in BE) is set to ‘Expired’. Customer is allowed to pick up a bid and continue with the purchase. If the customer select a single bid and continues, the selected bid status is set to ‘Winning’ and remaining bid status are set to ‘Rejected’ [239,240]

Customer is also allowed to pick up multiple bids and initiate a reverse bidding process.

All bids which are not selected by the Customer are set to ‘Rejected’ [241,242,243,244].

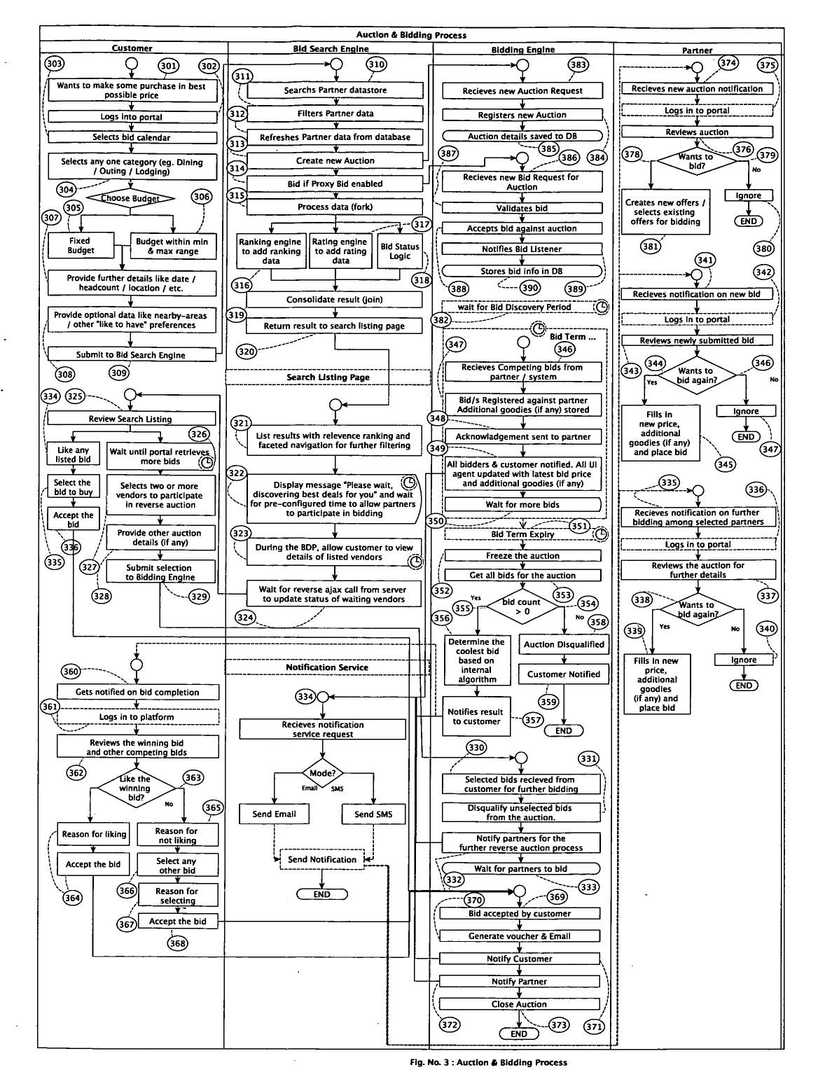

FIG. 3: Auction & Bidding Process shows the process and flow of auction and bidding in the system.

As shown, the customer provides all details in the Bid Calendar (BC) and submit for bid search [301-309]. The Bid Search Engine (BSE) receives the bid search request and starts processing. The BSE identifies all the eligible bids [310-312]. The BSE creates a new Auction [313,384,384,385]. The BSE places all eligible bids against this auction [314,386,387,388,389,390]. None, few or all bids may be in “Pending Review” state. Bid in “Pending Review” state requires that the partner must provide one or more offers for bidding against the auction. Partners are notified about the new auction. Partners interested in bidding are expected to provide one or more offers (new/existing) for bidding within the Bid Discovery Period (BDP) [374,375,376,377,378,381]. Partner may decide to skip the auction [379,380]. The Bid Search Engine (BSE) accepts the initial bid from the partners until the expiry of Bid Discovery Period (BDP) [382]. Customer may choose to wait until the expiry of Bid Discovery Period (i.e. for the partners to approve the bids) which can be beneficial for the customer as he/she can get more options to choose from [322-323]. Customer may choose to buy (i.e. using ‘Buy Now’ option) any of the listed “Accepted” bid at any point of time [334]. Customer may choose to further allow negotiation among the listed bids [327]. If customer wants to further allow negotiation among the listed bids, he or she can select two or more “Accepted” bids from the listing and add those for bidding process [327]. Customer can define the Bid Term (BT) for the bidding process. In no BT is defined, the platform determines the BT based on it's internal algorithm [328]. Customer can optionally provide more information on his/her expectation on the goods or services he/she is looking for [328]. The chosen list of “Accepted” bids along with other information (if any) are submitted to the Bidding Engine (BE) [329]. The Bidding Engine (BE), disqualifies the bids which aren't part of the selected list of bids [329-330]. The Bidding Engine (BE) notifies the partners about disqualification of their bid/s [329-330]. Partners for the chosen bids are notified and are requested to bid further [332]. Reverse bidding process (RBP) is considered here where the partners are expected to provide a bid with lower monetary value (i.e. higher benefits for customer) then the current bid [332]. Partner receives the notification for further bidding [335]. Partner logs into the portal [336]. Partner reviews the details of the auction (i.e. customer may have provided more details) [337]. Partner may stop to bid further if he/she wants to opt out of the bidding process [340]. Partner may choose to either lower the price or provide more benefits in the same budget [339] and place a bid. All participating bidders are notified for every new bid placed [341]. This bidding process will continue for a predefined Bidding Term (BT) [346-350]. Partner may review bids placed by other partners [342,343]. Details of other participating partners are not revealed to the Partners during the Bidding Term (BT). Details of the customer are not revealed to the Partners during the Bidding Term (BT). Details of participating partners are revealed to the customer. Partner may bid one or more times to outbid other partners during the Bidding Term (BT). Once the Bidding Term (BT) expires, the Bidding Engine (BE) stops accepting bids for the auction [351-352]. The Bidding Engine (BE) evaluates all the qualified bids and picks up a Coolest Bid [353]. The qualified bids are the last bid for the partner and offer combination. The selection of the coolest bid is based on the Bidding Engine's (BE) internal algorithm [356]. The customer is notified about the Bidding Term (BT) expiry and is presented with the coolest bid as well as the other qualified bids [357]. Customer reviews all the qualified bids [361,362]. Customer is free to either choose the coolest bid or any other qualified bid listed in the final list. The customer chooses a bid, reviews it and accepts the bid [360,361,368]. If the customer is picking up the wining bid, reason for liking the wining bid is captured from the customer [364]. This data helps the system to understand the customer's buying behavior/pattern. If the customer is not picking up the coolest bid, reason for not liking the coolest bid is captured from the customer [365]. This data helps the system to understand the customer's buying behavior/pattern. Reasons for choosing a particular bid (from list of other qualified bids) is collected from the customer [367]. This data helps the system to understand the customer's buying behavior/pattern. The Bidding Engine (BE) receives the bid acceptance request [369]. The winning bid is registered in the platform. The auction detail in the platform is updated with latest data. Data pertaining to Customer buying behavior is feeded to the analytical engine. All the partners participating in the bidding process are notified about the result [371]. The winning bidder (partner) is notified about all the details of the auction [372]. The Bidding Engine (BE) notifies the Deal Voucher Service (DVS) about the winning bid [370]. The DVS generates one or more vouchers (based on the item count) with unique voucher code [370]. The voucher/s details are persisted in the database [370]. The voucher/s details are then emailed to the Customer's registered emailId [370]. The voucher/s details can be also viewed in the bidding portal ‘My Voucher’ section. The auction is set to ‘Closed’ by the Bidding Engine (BE) [373].

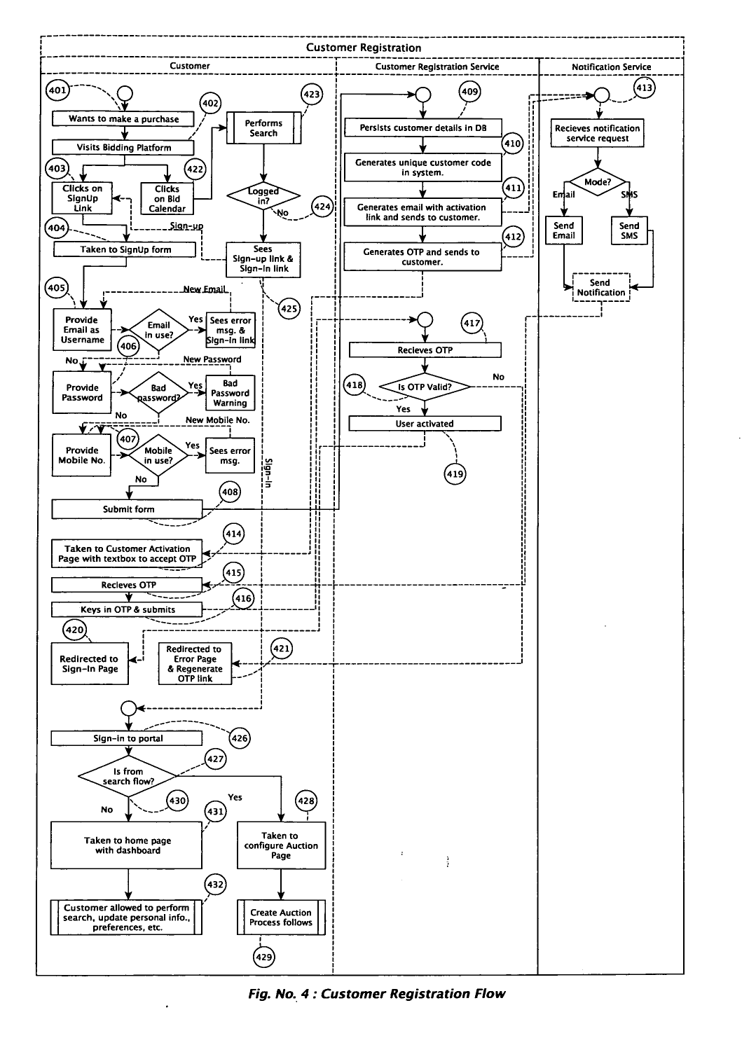

FIG. 4: Customer Registration Flow illustrates flow chart for the customer registration process.

Customers are the consumers of services or goods. Customers searches for services or good within their desired budget in the platform. The search request is considered as an Auction by the system. Partners place one or more bids against this auction.

As shown in FIG. 4, user comes to the platform/portal, looking to purchase goods or service within his/her budget [401,402]. User clicks on ‘Signup’ link to register [403]. User is taken to the sign-up form [404]. User is asked to enter the emailId as username [405], User enters the emailId. Platform validates the format of the emailId, throws error in case of invalid format. Platform checks if the emailId is already in use. If already in use, error message is shown to the user. ‘Signin’ link is also displayed to the user, incase the user wants to sign-in using the existing emailId. User is asked to provide the password [406]. User provides the password. Platform validates the password against the password policy defined in the platform. Error message is displayed if the password doesn't adhere to the password policy. User is asked to provide the mobile number [407]. User provides the mobile number. Platform validates the format of the mobile number, throws error in case of invalid format. Platform checks if the mobile number is already in use. If already in use, error message is shown to the user. User clicks on the ‘signup’ button to submit the form [408]. The CRS (Customer Registration Service), accepts the user registration request. The CRS persists the user details as new customer into database [409]. The new customer status is set to ‘Inactive’ [410]. The CRS creates a message with ‘Customer Activation Link’ and emails it to the customer's registered emailId [411]. Instructions related to activation of the customer is also included in the email. The CRS generates an OTP (One Time Password) and sends it to customer's registered mobile number [412]. Customer receives the email as well as the SMS [414]. Customer is taken to the OTP verification form where he/she keys in the received OTP [415]. Customer submits the OTP verification form [416]. CRS receives the OTP verification form request [417]. CRS validates the OTP [418]. If entered OTP is incorrect, the customer is taken to error page. If entered OTP is correct, CRS activates the customer record in the platform [419]. User is redirected to the ‘sign-in’ page.

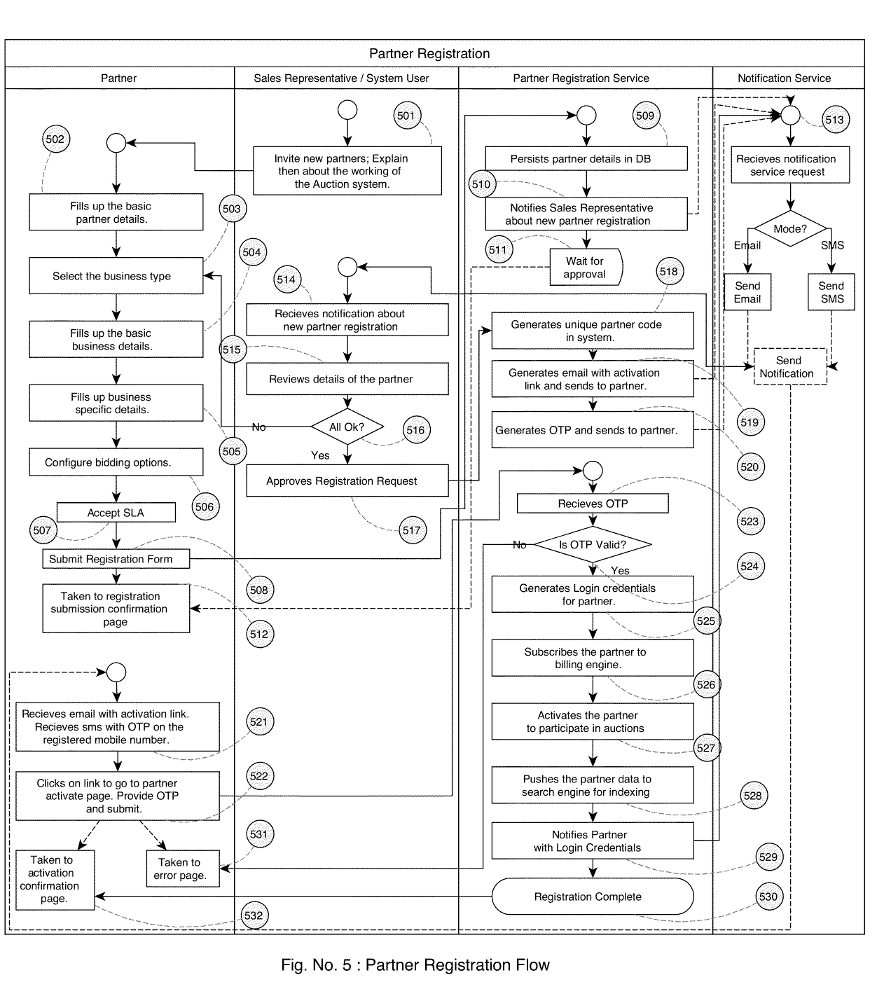

FIG. 5: Partner Registration Flow illustrates the flow chart for the partner registration. This software platform allows self registration of partners. Partners are the sellers/providers/vendors of goods and services. Partners or vendors are the bidders in this bidding platform.

As shown in the FIG. 5, SR meets the partner representative and explains about the process and benefits [501]. Once the partner is convinced, he or she is taken through the self registration wizard. Partner provides the basic information [502] and presses next. Partner is asked to select the business type [503]. On selecting the business type, the business specific data entry form is presented to the partner [504,505]. Partner provides the business related information and presses next. Partner can then configure the bidding options [506]. Partner can enable/disable auto-bid option using the bidding-options form. Partner can build bidding rules using the BiddingRulesBuilder console.

Bidding options configuration is optional and can be configured later. On pressing ‘next’, partner is taken to the SLA page [507]. Partner is suppose to read and accept the SLA. On accepting the SLA, the partner registration form is submitted to the PRS (Partner Registration Service). The PRS takes the partner registration request and persist in the database [509]. A partner on-boarding business process is initiated by the PRS. As part of the partner on-boarding business process, a notification is sent to the SR [510] for verification and approval. The partner is taken to the registration confirmation page [512]. SR receives the notification [514]. SR logs into the platform using his/her credentials. SR reviews the partner registration request details. SR can request for more information from the partner if certain informations are missing [516]. If all details are fine, SR can approve the partner registration request. On approval, the PRS generates an unique code for the partner [518]. The PRS creates a message with ‘Partner Activation Link’ and emails it to the partner's registered emailId [519]. Instructions related to activation of the partner is also included in the email. The PRS generates an OTP (One Time Password) and sends it to partner's registered mobile number [520]. Partner receives the email as well as the SMS [521]. Partner clicks on the activation link embedded in the email [522]. Partner is redirected to OTP verification form where he/she keys in the received OTP [522]. Partner submits the OTP verification form [522]. PRS receives the OTP verification form request. PRS validates the OTP. If entered OTP is incorrect, the partner is taken to error page. If entered OTP is correct, PRS generates the Partner record in the platform. The PRS generates login credentials for the partner [525]. The partner is provisioned to the billing engine [526]. The partner is provisioned to the bidding engine and is enabled for bidding [528]. The partner record is pushed to the search engine foe indexing [528]. An email is sent to the partner with his/her credentials to the partner's registered emailId. The registration process completes here. The partner can now login into the platform and configure offers.

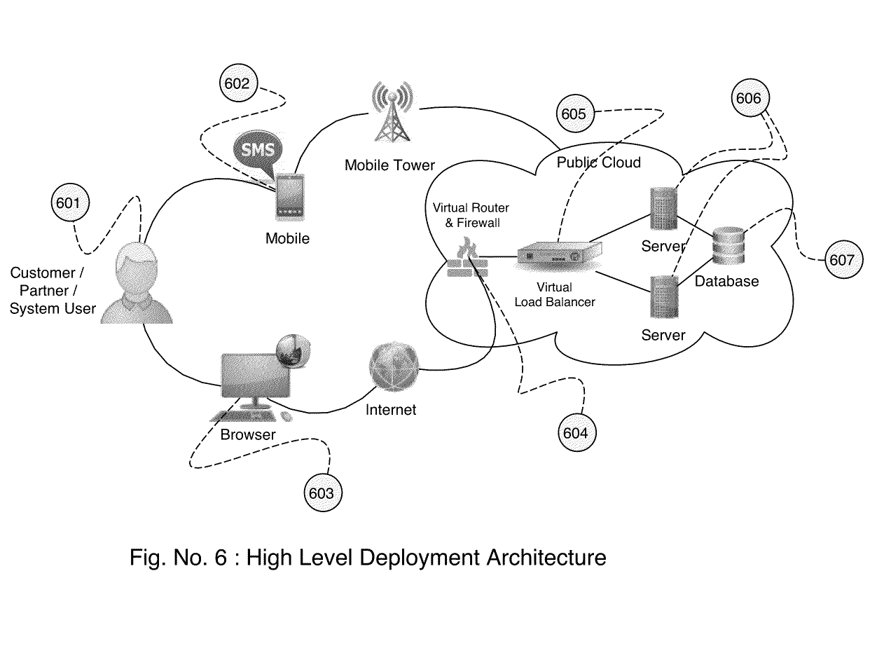

FIG. 6: High Level Deployment Architecture illustrates the deployment of this software platform in a distributed computing environment. FIG. 6 shows the deployment of the software platform in multiple computers/servers and accessed by clients over the network.

The software platform described as part of the invention may be best implemented using Object Oriented programming language like Java or ASP.NET. It may be implemented using scripting language like PHP or Python. It can also be implemented using procedural programming language like ‘C’.

As shown in FIG. 6, servers [606], database [607], loadbalancer [605], firewall [604] deployed within cloud and clients [601] connected to the software platform using bowser client [603] or mobile device [602] over the internet or mobile network.

The client [601](i.e. System Admin/Partner/Customer/Guest) may access the software platform using bowser client [603] over the internet. Any http/https client available in a desktop or a laptop or a tablet or a smart phone may access the platform.

The software platform is protected behind a virtual firewall [604], which fundamentally, prevents traffic from reaching a protected network.

The virtual load balancer [605] may be used for distributing incoming traffic among multiple servers hosting the software program. By balancing application requests across multiple servers, a load balancer prevents any application server from becoming a single point of failure, thus improving overall application availability and responsiveness.

Web server [606] includes a software engine that delivers web applications. Web server helps to deliver web content that can be accessed through the Internet over HTTP/HTTPS protocol. The software platform described as part of the invention requires to be deployed in a web server. The server [606] may be a open source Java/JEE server like Tomcat/Jboss or Apache Server or commercial servers like Weblogic/IIS/Websphere etc.

The database server [607] serves data from a database, which is a repository for data used by server 606 during the course of operation. The database of database server [606] may adhere to any one of the flat model, hierarchical model, object-oriented model or a relational model for databases.

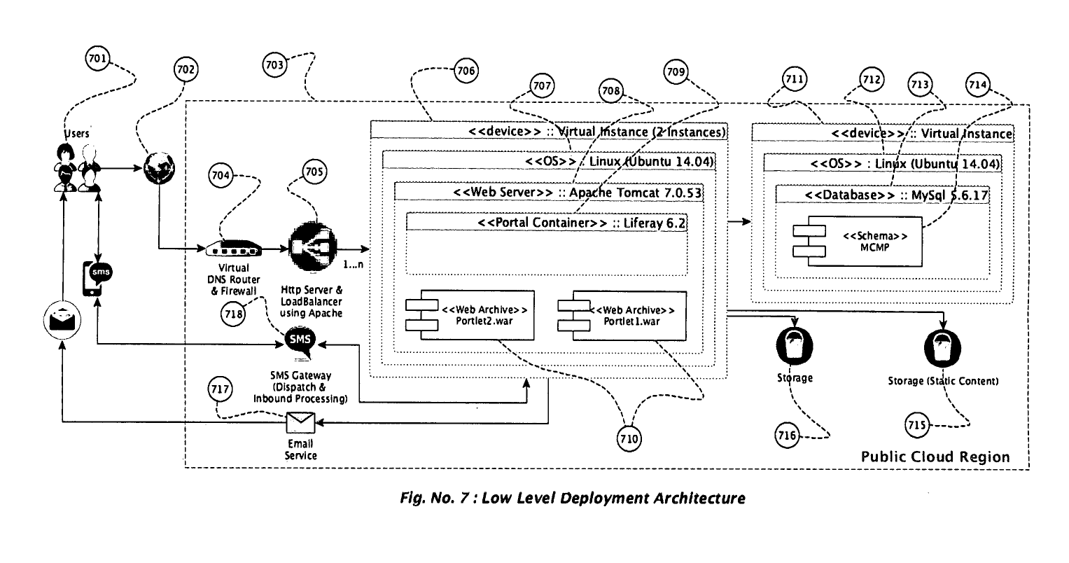

FIG. 7: Low Level Deployment Architecture illustrates the topological model of the software platform in a distributed computing environment. This figure describes the details of software platform implementation using Java/JEE technologies.

As shown in FIG. 7, the client [701](i.e. System Admin/Partner/Customer/Guest) may access the software platform using bowser client over the internet [702]. Any http/https client available in a desktop or a laptop or a tablet or a smart phone may access the platform. The software platform is protected behind a virtual firewall [704], which fundamentally, prevents traffic from reaching a protected network. Any virtual firewall like pfSense or Vyatta community version may be used. Along with firewall, pfSense or Vyatta provides virtual router functionality which may be configured.

Apache Http Server may be used as the Http Server and the load Balancer [705]. Apache Http Server is an open source http server available for Unix and Windows platform. Apache web-server may be also used as load-balancer using its modules mod_proxy, mod_proxy_ajp and mod_proxy_balancer. These modules are part of Apache web-server distributions. AJP protocol may be used for communication between Apache Http Server [705] and the Web Server hosting the software program [708].

Server [706] holds the software engine that delivers the web application. The server may be a virtual instance acquired in any public cloud. For live environment, Ubuntu may be used as the Operating System [707]. A .war file is the web deployment unit for Jave/JEE application. A Java/JEE based we container is needed to deploy the .war file. Apache Tomcat Java/JEE based web server may be used to deploy the software program [708]. Java/JEE based Portal container like Liferay may be used to provide portal feature to the clients [709].

The database server [711] serves data from a database, which is a repository for data used by server [706] during the course of operation. The server [711] may be a virtual instance acquired in any public cloud. For live environment, Ubuntu may be used as the Operating System [712]. MySQL, a RDBMS may be used as the database provider [713]. MySQL community version is an opensource database and can be deployed in either Unix or Windows OS.

For storing data in file system, storage service (Block/Object Storage) provided by Cloud vendor can be utilized [715, 716]. All static contents of the software platform [715] can be pushed into the storage. All application transaction files/data can too be stored into the storage [716].

For all notifications to be sent to the Partner/Customer/System Admins, Email Service [717]& SMS service [718] may be used. The public cloud provider may have pay-and-use Email Service [717]& SMS service [718]. If not, there may be many Email Service [717]& SMS service [718] providers ready to provide the service based on subscription.

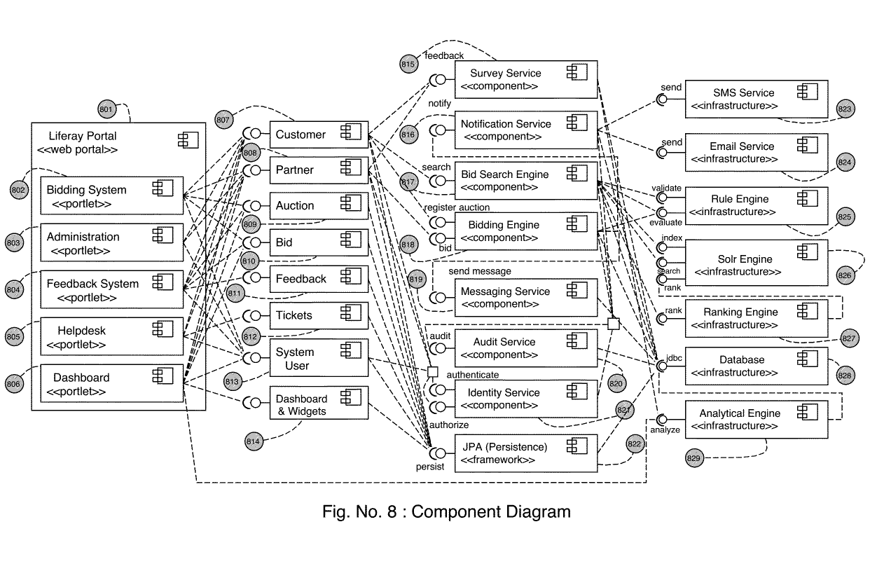

FIG. 8: Component Diagram illustrates the different components in this system.

As shown in the figure, the Bidding platform is a software platform having number of modules performing various functions and working seamlessly together. FIG. 8 illustrates the main modules of the platform if built in an object oriented programming environment like Java/JEE technologies. [801] The portal may be built on top of portal framework like Liferay. Liferay Portal is a free and open source web platform written in Java. It has features commonly required for the development of websites and portals. [802] Bidding System is a browser based presentation module which provides online bid search, auction and bidding facility to partners, customers, system and guest users. This module is a portlet. The Bidding System component offers variety of features like, a) provides the Bid Calendar page where customer/guest user can perform search for bids, b) provides user interface for customer (logged in) where customer can perform bid search, view their notifications, ongoing auctions, auction history and other auction related details, modify ongoing auctions, accept/reject auctions, etc, c) provides user interface for partner (logged in) where partner can view all the notifications, ongoing auctions, bid history and other auction related details, place bids, accept/reject auctions, etc., create and manage offers and view bid grid, and c) provides user interface for system user (logged in) where system user can manage the auction and bidding process (if necessary)

[803] Administration system is a browser based presentation module which provides administrative functionality to partners, customers and system users. This module is a portlet. The Administration system component offers variety of features like, self registration wizard for partner, self registration wizard for customer, user management interface for system user, user interface for customer (logged in) where customer can manage his/her profile, change his/her security credentials, manage his/her preferences pertaining to the functionality of the platform. This provides user interface for partner user (logged in) where partner user can manage customer profile, business details, their users and their profiles, manage customer preferences pertaining to the functionality of the platform, provides user interface for system user (logged in) where system user can view the health of the platform, view and track activities performed in the platform, manage his/her profile, change his/her security credentials, manage his/her preferences pertaining to the functionality of the platform.

[804] Feedback System is a browser based presentation module which allows customers & partners to provide feedback on the products & services. This module is a portlet. The Feedback System component offers variety of features like, provides user interface for customer (logged in) where customer can rate and provide feedback for the products & services he/she utilized, rate and provide feedback on the vendor, Review the feedback provided by vendor, View history of all feedbacks provided. This provides user interface for partner (logged in) where partner can rate and provide feedback on the customer, review feedbacks provided by customer, provide response of the feedback, views various reports based on the feedbacks provided by customer, perform various analysis using the analysis tool to understand customer behavior, what's going wrong and what's going right, provides user interface for system user (logged in) where system user can monitor overall feedbacks provided by the customers, and perform various analysis using the analysis tool to understand partners performance.

[805] Helpdesk is a browser based presentation module which provides the customer with information and support on the products and services the platform is providing. The Helpdesk System component offers variety of features like: provides user interface for customer (logged in) where customer can create support tickets, track his/her support tickets, manage his/her support tickets, provides user interface for partner (logged in) where partner can create support tickets, track his/her support tickets, manage his/her support tickets, resolve support tickets if required, provides user interface for system user (logged in) where system user can create support tickets, track his/her support tickets, track assigned support tickets, provide resolution for the support ticket.

[806] Dashboard is a browser based presentation module designed to display summaries, graphics and gauges which provides the customer/vendors information to track all functions.

[807] Customer component provides the capability to define and maintain the data used by a business to track and service its customers. In the platform, customers are consumers of the goods or services. The customer component offers variety of features like: defines the information used by the platform to record, maintain, track and service customers of the platform, holds the contact information responsible for communication between the platform and it's customers, maintains the relationship between customer and other components that may contain information relevant to customer.

[808] Partner component provides the capability to define and maintain the data used by a business to track and service its partners. In the platform, partners are provider/producer of the goods or services. The partner component offers variety of features like: defines the information used by the platform to record, maintain, track and service partners of the platform, holds the contact information responsible for communication between the platform and it's partners, maintains the relationship between partner and other components that may contain information relevant to partner.

[809] Auction component provides the capability to define and maintain the data used by a business to track all the auctions created by the customers of the platform. In the platform, auction is the process of buying (i.e. by consumer) and selling (i.e. by producer) of the goods or services. The auction component offers variety of features like: defines the information used by the platform to record, maintain, track auction process in the platform, holds all the search information provided by the customer in the bid calendar, holds the information of the auctioneer and the bidders, maintains the relationship between the auctioneer and the bidders, maintains the relationship the bidders and their bids, holds the information of the winning bid, maintains the relationship between auction and other components that may contain information relevant to auction.

[810] Bid component provides the capability to define and maintain the data used by a business to track all the bids created by the partners of the platform. In the platform, bid is the value offered by the producer/provider for the goods or services. The bid component offers variety of features like: defines the information used by the platform to record, maintain, track a bid in the platform, holds the information provided by the bidder for the specific bid, maintains the relationship between bid and other components that may contain information relevant to bid.

[811] Feedback component provides the capability to define and maintain the data used by a business to track all the feedbacks provided by the customers/partners of the platform. In the platform, providing feedback is the process where producers & consumers for the goods or services can provide rating and feedback for the goods or services which can be analyzed and utilized to enhance the user experience in the platform. The feedback component offers variety of features like: defines the information used by the platform to record, maintain, track a feedback in the platform, maintains the relationship between feedback and other components that may contain information relevant to feedback and maintains the relationship between bid and other components that may contain information relevant to bid.

[812] Tickets component provides the capability to define and maintain the data used by a business to track all the support tickets filed by the customers/partners of the platform. The ticket component offers variety of features like: maintains inquires, questions and resolution raised by customer, maintains inquires, questions and resolution raised by partners, maintains resolution provided by system user, maintains the relationship between ticket and other components that may contain information relevant to ticket.

[813] System User component provides the capability to define and maintain the data used by a business to track and service its system users. In the platform, system users are the ones who manages and maintains the platform. The System User component offers variety of features like, defines the information used by the platform to record, maintain, track and service system user of the platform, holds the contact information responsible for communication between the platform and it's system users.

[814] Dashboard and Widgets component provides the capability to define and maintain the data used by a business to display customized dashboard and widgets to partners, customers & system users. The dashboard and widgets component offers variety of features like, defines the information used by the platform to build a dashboard in the platform, holds the customization done to specific dashboards by the customer or partner, defines the information used by the platform to build a widget in the platform, holds the customization done to specific widget by the customer or partner, maintains the relationship between dashboard and widgets, maintains the relationship between dashboard and other components that may contain information relevant to dashboard, maintains the relationship between widget and other components that may contain information relevant to widget.

[815] Survey service component provides the platform with capability to manage feedbacks in the platform. This is the backend service and provides business methods to perform a) Initiate a feedback business process (workflow), b) Fetch details of a feedback, c) Fetch all feedback, d) Fetch selective feedbacks based on filters like by Customer/by Partner/by BusinessType/by Date, Update a feedback, Approve a feedback, Reject a feedback and Create report on feedback.

[816] Notification service component provides the platform with capability to send notification to the intended recipient using various notification mechanism like email, sms etc. New notification mechanisms can be easily plugged in. This is the backend service and provides utility methods to perform a) Send notification to single recipient and b) Send notification to multiple recipients.

[817] Bid Search Engine component provides the platform with capability to perform search live bids based on customer bid search criteria. This is the backend service and provides business methods to perform Search bids based on search criteria

[818] Bidding Engine component provides the platform with capability to manage auction and bids. This is the backend engine and provides business methods to perform a) Create a new auction based on search criteria, b) Fetch auction details, c) Update auction details, d) Rejects auction, e) Invalidate auction, f) End auction, g) Place bid on auction, h) Fetch all bids for auction, i) Fetch winning bid for auction, j) Fetch final bids for auction, k) Fetch all active auctions, and i) Fetch all active auction by customer/partner.

[819] Messaging Engine component provides the platform with capability of asynchronous communication among components. This component helps the platform in decoupling the components. This is the backend engine and provides utility methods to perform Make async Api call to another component.

[820] Audit Service component provides the platform with capability of auditing all the business methods in the platform. The audit data would be used by the platform for performing business analytics. This is the backend service and provides utility methods to perform Audit method.

[821] Identity Service component provides the platform with capability of Authentication & Authorization of the users of the platform. This is the backend service and provides business methods to perform such as Authenticate User, Validate token, Add User, Update User, Update User credentials, Delete User, Suspend User, Activate User, Get roles of user, Get User Details by Id, Get All Users for tenant, Get tenants, Get tenant details, Update tenant, Delete tenant, Get roles for tenant and Get all roles.

[822] Persistence Service component provides the platform capability to manage persistent objects. Persistence Service internally uses database specific drivers to manage the data in the database. This is the backend service and provides business methods to perform such as save object, remove object, get object, find object by id and find object by custom search criteria.

[823] SMS Service component provides the platform capability to send SMS to a intended mobile number. SMS Service is used by the Notification service for sending SMS. This is the backend service and provides business methods to perform a) send SMS and b) send group SMS

[824] Email Service component provides the platform capability to send Email to a intended email address. Email Service is used by the Notification service for sending Email. This is the backend service and provides business methods to perform a) send Email and b) send group Email

[825] Rule Engine component provides the platform capability to validate, parse and execute business rules which are in form of expression. Rule Engine may be used by other internal components like Bid Search Engine, Bidding Engine. This is the backend service and provides business methods to perform a) validate expression, b) parse expression and c) evaluate expression.

[826] Solr Engine component provides the platform capability to perform full-text search on huge amount of data. Solr Engine may be used by other internal components like Bid Search Engine. This is the backend service and provides business methods to perform such as perform search, index data and rank search.

[827] Ranking Engine component provides the platform capability to perform ranking of bids on the bid search result. Ranking Engine may be used by other internal components like Bid Search Engine. This is the backend service and provides business methods to perform ranking of bids.

[828] Database component provides the platform capability to define, persist, retrieve, update, delete and administrate data used by the platform. Database is be used by almost all data agnostic components. Platform uses database specific drivers to connect to different database.

[829] Analytics Engine component provides the platform capability to perform various business analytics on the data captured by the platform. The results of various business analytics are made available to customers, partners & systems users (based on the privilege) in dashboard and in form of reports.

FIG. 9: Bid State Diagram illustrates different states of a bid. As shown in the figure, each of the ovals in the state machine diagram represents a state of a bid and the text adjacent to the arrows (edges) represent transitions from one state to another as caused by the input.

1. A computer implemented real time software system, which has a new method for searching for live bids for goods or service with the customer's desired budget/price and preferred vendors;
wherein the buyers/customers input the desired price or budget with the list of goods or services they intend to buy to the computer search system;
upon receiving the search results based on the search input/criteria, the customers will be able to purchase the goods or services from the sellers/partners through a fully automated auctioning and bidding process using reverse auction process.

2. A software/computer implemented bid search system, comprising:
receiving request from customers from the browser over the internet as input parameters for search, the search/input parameters includes the information related to goods or services, desired budget or price, bid discovery period and the date on which the customer would like to avail the services or receives the goods;
wherein the system creates an auction automatically upon receiving the search information/parameters;
wherein the platform/system identifies if the bid discovery period defined by the customer is sufficient to discover the bids;
wherein the system discovers the registered sellers in the system by searching the seller's database with the desired goods, services, budget/price and other relevant information pertaining to the customer's search request parameters;
wherein the bid search result contains bids with ‘Accepted’ and ‘Pending Review’ status;
wherein the platform suggest the customer to extend the bid discovery period for better results if the platform identifies shorter bid discovery period;
wherein partners are expected to place their initial bids within the bid discovery period;
wherein the complete bid search results with initial bid price on each accepted bid will be published or shown to the customer on or before the expiry of the bid discovery period.

3. A software/computer implemented bid search system, comprising:
wherein the customers login into the portal and visits the “Bid Calendar” (a search web page pertaining to this system), fill-in the required details such as the information related to goods or services, desired budget or price, bid discovery period and the date on which the customer would like to avail the services receives the goods in the bid calendar and clicks on the search bid;
the Search Engine performs full text search in the partner/sellers indexed data and this result is passed to the DataLoader computer program/component;
DataLoader loads the latest data from relational database;
the latest partner dataset is passed to the computer program, which evaluates various rules defined in the “Bidding Options” for each partner/seller and accordingly determines the eligibility of the partner for bidding;
wherein the said computer program will also validates whether the budget of the customer for the desired good/service matches with one or more of the configured offers against each eligible partners;
all the eligible offers with partner records are added to a list based on the output from the filtered list;
upon receiving the offers list, if there is at least one eligible offer in the list, a new auction will be created in the system;
wherein the list of eligible offers are then passed to the “OfferBidEngine” computer program;
wherein the partner has “auto-bid” option enabled, then the system places a new bid against the new auction on behalf of the partner;
wherein the offer with ‘Accepted’ bid status along with price is added to a search bid list;
wherein if the partner has “approval-required” configured, an approval flow is initiated by the system;
wherein the offer with ‘Pending Review’ bid status (price set a ‘none’) is added to a search bid list;
as part of approval flow, the partner will be notified (via SMS & Email) about the new auction;
wherein the partner is required to provide price and approve the bidding task;
the final bid list is simultaneously passed on to various computer programs/engines in the system for enriching;
wherein the Ranking computer program/engine takes care of ranking each bid as per the bid search criteria;
wherein the Rating computer program/engine takes care of attaching the ratings of each offer based on user feedback on the partner, user feedback on the offer and other factors;
the final bid search result are sorted by Ranking and then by rating;
wherein the final search result is serialized and written back to the response;
the search response will be built in the search listing page;
the bids with ‘Accepted’ bid status are listed with ‘Price’ & two buttons i.e. ‘Buy Now’ & ‘Add to negotiate’;
wherein the bids with ‘Pending Review’ bid status are listed with “Pending Review” displayed in the ‘Price’ section. ‘Buy Now’ & ‘Add to negotiate’ buttons are in disabled state;
a ‘reverse ajax’ listener is initialized for listening to server's notification on ‘Pending Review’ bids;
wherein the bidding engine computer program/component will ensure that the ‘Pending Review’ bids would be made available to the customer before the expiry of bid discovery period for bidding/purchase provided the partner accepts to bid with the existing or new offers;

4. A method as recited in claim 3, wherein the “Bid Calendar” is a Bid Search form where the customer can provide budget/date/other search criteria to perform bid search in the platform using the ‘bid search engine’.

5. A method as recited in claim 3, wherein the search engine or bid search engine is a software component which is responsible for performing search of all bids matching the search criteria, ranking and rating the search result;
wherein the bid search engine will ensure to identify, enrich, optimize, coordinate and present all the eligible bids available in the bid database to the customer.

6. A method as recited in claim 3, wherein the “OfferBidEngine” computer program loops through each eligible partner and picks up all the offers matching the criteria and budget of the customer;
wherein if the partner has opted to create the offers at run time then the OfferBidEngine communicates to the partner/vendor to build one or more offers matching the search criteria and the budget and submits the new offer or offers details with the initial bid price or prices to the system;
wherein, the system will build the offer with the initial bid price and show it to the customer as part of the search results upon receiving the new offer request from the partner/vendor.

7. A method as recited in claim 3, wherein during the bid discovery period, the partners receives notification from the notification service computer program regarding the new auction;
upon receiving the notification, the partners need to login into the system and required to provide or configure offer/s (i.e. new/existing) based on the customer requested goods or services for bidding within the Bid Discovery Period if partners opted for dynamic offers, otherwise partner can respond or act on the new auction by either login to the portal or sending an SMS on the acceptance of the auction with the initial bid price;
as soon as the computer program/server receives one or more offers for bidding, bid/s are placed against the auction on behalf of the partner;
wherein If the partner places one or more bids within the Bid Discovery Period, the bid/s status is/are set to ‘Accepted’;
wherein the computer program/system pushes one or more new bid details to the browser over the network;
wherein the browser (using reverse AJAX) picks up the bid details and updates the bid search listing accordingly;
if the partner fails to place any bid within the Bid Discovery Period, the bid status (in bid listing page as well as in the Bidding Engine computer program) is set to ‘Expired’;
wherein the customer is allowed to pick up a bid and continue with the purchase;
wherein if the customer selects a single bid and continues, then the selected bid status is set to ‘Winning’ and remaining bid status are set to ‘Rejected’ (FIG. 9);
wherein the customer is also allowed to pick up multiple bids and initiate a reverse bidding process;
wherein all the other bids which are not selected by the Customer are set to ‘Rejected’;
wherein all the partners pertaining to the “Rejected” bids are notified regarding rejection of their bid;
wherein all the partners pertaining to the “Rejected” bids are notified regarding rejection of their bid;
wherein all the partners pertaining to the “Selected” bids are notified for further bidding;
wherein all the bids which are selected by the Customer for further bidding are set to ‘Selected’;
wherein the partner can further bid with lower monetary value or higher worth value;
wherein the partners can place multiple bid within the BidTerm period;
wherein on the expiry of BidTerm period, the auction stops accepting further bids;
wherein the system determines the “Cool” bid based on internal algorithms;
customer purchase behavior and historical data;
wherein the customer is notified about the end of the auction;
wherein the customer can login to the platform using his/her credentials and review the “Cool” bid and the “Closing” bids;
wherein the customer can go ahead with the purchase of the “Cool” bid and ignore the “Closing” bids and the customer is presented with a form to fill up on what he/she liked about the “Cool” bid;
wherein the customer can go ahead with the purchase any one of the “Closing” bids and ignore the “Cool” bid and the customer is presented with a form to fill up the reason for ignoring the “Cool” bid and what he/she liked about the selected bid;
wherein once the customer purchases a bid, purchased bid state is set to “Winning” and remaining bid states are set to “Outbid”;
wherein coupon code/s are generated for the “Winning” bid;
wherein email is sent to the customer with coupon code/s;
wherein the partner pertaining to the “Winning” bid is notified;

8. A method as recited in claim 3, wherein the partners interested in bidding are expected to provide one or more offers for bidding within the Bid Discovery Period if they intend to add more offers during this period.

9. A method as recited in claim 1, wherein the sellers/partners/vendors are registered through the system.

10. A method recited in claim 1, where in the customer (s) can search for live bids on the required good or service within a desired budget (fixed or flexible) set by them.

11. A method recited in claim 1 wherein the customers can fill-in the details in the bid calendar and search for a meal or meal for a group in the restaurants (registered partners in the system) with the desired fixed budget set by them and purchase the offer through reverse bidding process by choosing one or more offers.

12. Bid search system recited in claim 1 wherein the customers can fill-in the details in the bid calendar and search for live bids for an Item or a group of (collection of) items from the registered retail partners.

13. Bid search system recited in claim 1 wherein the customers can fill-in the details in the bid calendar and search for live bids for an entertainment event for a person or a family or a team or group with the desired fixed price set by them.

14. Bid search system recited in claim 1 wherein the customers can fill-in the details in the bid calendar and search for live bids for a hotel/accommodation for a person or a family or a team or group with the desired fixed price set by them

15. The system of claim 1, wherein the communication between the customer (buyer) and partner (Seller) happens through the My budget My choice automated bid search engine's Bid Communication component without having the direct communication between the customer and the buyer; wherein in other words, the My budget My choice automated bid search engine's Bid Communication component takes care of the responsibility of all necessary communication on behalf of the customer and the partner.

16. The system of claim 1, wherein the partners can choose options for participating in the bidding with computer code/program, namely, a) Self participation or b) System participation (Auto/System Bidder), self participation means the sellers/Bidders/vendors/partners can participate in bidding process and bid for the auction, where as the system participation (Auto/System Bidder) means the bidding engine program/system will participate in the bidding process and bid on behalf of the partner.

17. The system of claim 7, wherein the partners can request for bidding summary report (called as BID GRID in this system) for a particular auction;
wherein a computer program, which will generate a report in a tabular/grid form on the bidding details of all the partners/bidders of that particular auction;
wherein the BID GRID will help the partners to analyze the bidding strategy of other partners and improve their bidding skills for future auctions;
wherein the other partners details (E.g. Name, location, etc) will be masked in the bid grid.
